(19) United States
(12) Patent Application Publication
(10) Pub. No.: US 2022/0387902 A1
(43) Pub. Date: Dec. 8, 2022

(54) A LINEAR MANIPULATOR FOR A PROGRAMMABLE STAGE INSTALLATION, A BODY FOR A LINEAR MANIPULATOR AND USE OF A LINEAR MANIPULATOR

(71) Applicant: WAHLBERG HOLDING APS, Viby J (DK)

(72) Inventor: Mads Wahlberg, Viby J (DK)

(21) Appl. No.: 17/774,827

(22) PCT Filed: Nov. 3, 2020
(86) PCT No.: PCT/DK2020/050298

§ 371 Date: May 5, 2022

(30) Foreign Application Priority Data
Nov. 5, 2019 (DK) PA 2019 70681

(51) Int. Cl. A63J 1/02; B25J 19/00; B25J 5/02; B25J 9/10

(52) U.S. Cl. CPC A63J 1/02; A63J 1/028; B25J 19/0029; B25J 5/02; B25J 9/104

(57) ABSTRACT

Various embodiments of the present disclosure are directed to, for example, a linear manipulator for a programmable stage installation. In one embodiment, the linear manipulator includes a body having an internal longitudinal channel extending parallel to an axis between two channel points, a power conductor positioned inside the channel, a drag band extending parallel to the axis, a motor that drives the drag band, and a wagon. The body further including a longitudinal opening extending between the two channel points, and a pair of rails connected to the body and extending parallel to the axis. The wagon including a pair of rail grippers for slidably engaging the pair of rails, a band connector connected to the drag band, and a power connector. The wagon attaches to equipment to be displaced along the linear manipulator and the power connector connects the equipment with the power conductor.

### FIELD OF THE INVENTION

The present invention relates to a linear manipulator for a programmable scene installation, a body for a linear manipulator and the use of such a linear manipulator for displacing equipment along a line.

### BACKGROUND OF THE INVENTION

Linear manipulators are well known within the art of stage installation.

In some instances the linear manipulator just displaces equipment back and forth along a straight line. In other instances the linear manipulator is further equipped with a DMX cable for controlling the equipment such that the equipment could move while being displaced along a line.

Power cables and signal cables, such DMX cables, extend along the linear manipulator for powering and controlling the equipment. The cables are installed with enough slack such that the linear manipulator may displace the equipment to a distal end without the cables being pulled out of sockets.

This increases the size of the entire installation as the slacked cord(s) hang(s) from the linear manipulator with the risk of other equipment gripping the cords, thus the present day linear manipulator requires some tolerance to decrease the risk of unwanted collisions with other equipment.

Furthermore, the present day linear manipulators are time consuming to install as they require proper installation of the cords and tests to make sure that there is no unwanted collision from any other equipment or persons.

The above mentioned problems increase as the entire stage installation becomes more complicated with more individually controlled parts i.e. lights, winches, track runners and so on.

Thus, there is a need for a linear manipulator which is more compact than the present designs and which allow for easier and faster installation.

### OBJECT OF THE INVENTION

It is an object of the invention to provide a linear manipulator, which overcomes the limitations of the prior art.

### DESCRIPTION OF THE INVENTION

In an aspect of the invention a linear manipulator for a programmable stage installation is provided.

The linear manipulator may comprise
a body, which may comprise an internal, longitudinal channel. The channel at least being parallel to an axis between two channel points, and a longitudinal opening extending between the two channel points, and a pair of rails connected to the body and extending parallel to the axis,
a power conductor positioned inside the channel and being capable of extending along between the two channel points for providing power,
a drag band extending parallel to axis,
a motor adapted for driving the drag band,
a wagon comprising a pair of rail grippers adapted for slidably engaging the pair of rails and a band connector connected to the drag band, the wagon may be adapted for attachment with equipment to be displaced along the linear manipulator, the wagon having a power connector adapted for connecting the equipment to be moved with the power conductor, wherein the pair of rails and the drag band at least extend between the two channel points relative to the axis.

Thereby, a compact linear manipulator is provided having fewer external parts, such as cables hanging like drapes along the linear manipulator as the power conductor is positioned inside the channel of the linear manipulator. This also enables faster installation of the linear manipulator as there are fewer external parts.

The linear manipulator can displace equipment between the two channel points. The distance between the two channel points may be above 0.1 m or 0.5 m or 1 m or 3 m or 5 m. The linear manipulator will typically be adapted for displacing equipment along a distance (equal to the distance between the two channel points), which is above 1 m as the positive effect of the linear manipulator increases with length.

The equipment to be displaced may be light equipment for providing light, or a winch or any other equipment used in a theatre.

The wagon may be replaceable such that the body of the linear manipulator can be used with different wagons having different designs.

In an embodiment, the channel may have a substantially rectangular shape.

In an embodiment, the pair of rails may be positioned inside the channel, this will enable the linear manipulator to be more compact and surprisingly, the displacement of the wagon is more stable when the pair of rails is positioned inside the channel.

The stability is increased further if the rails of the pair of rails face each other.

The power connector may be a cable or one or more carbon contacts.

The power connector may be a cable connected to one or more carbon contacts.

The power connector may have a female plug end for a male plug connected to the equipment to be moved.

In an embodiment, the wagon may comprise an internal part positioned inside the channel and the internal part may be connected to an external part positioned outside the channel.

The external part may be adapted for attachment with equipment to be displaced along the linear manipulator.

The external part may be adapted for attachment with equipment to be displaced along the linear manipulator by having T-tracks or C-tracks, thereby providing a simple solution for attachment of equipment.

In an embodiment, the wagon comprises a divider extending between the internal part and the external part. The divider may be adapted for extending through the opening.

In an embodiment, the linear manipulator may further comprise a signal conductor positioned inside the channel and being capable of extending between the two channel points for providing a control signal and the wagon comprises a signal connector adapted for connecting the equipment to be moved with the signal conductor.

Thereby, the linear manipulator can be used to displace and control more advanced equipment as a control signal can be sent to the equipment. The equipment can be more advanced light equipment or animatronics or any other theatre equipment needing power and signal.

The signal connector may be a cable or one or more carbon contacts.

The signal connector may be a cable connected to one or more carbon contacts.

The signal connector may have a female plug end for a male plug connected to the equipment to be moved.

In an embodiment, the linear manipulator may further comprise one or more cable chains, the one or more cable chains being positioned inside the channel and being capable of extending between the two channel points, the power conductor and/or the signal conductor being positioned inside the one or more cable chains and the one or more cable chains being connected to the wagon.

The one or more cable chains enable that the power conductor and/or the signal conductor can be a simple cord. The power conductor can be a power cord.

The one or more cable chains enable that the signal conductor can be a Cat 5 cable such as an Ethernet cable or a DMX cable or any cable adapted for sending a control signal.

A drag chain is inheritably able to change its extent along the channel and thus the drag chain must be able to have a position, wherein the drag chain has an extent along at least part of the channel between the two channel points, wherein the common extent is part of the extent of the drag.

The one or more drag chain(s) may be connected to the wagon, such that the cable chains and the wagon move in unison.

The internal part may comprise one or more T-tracks or one or more C-tracks, which can connect with the one or more cable chains.

In an embodiment, the channel comprises one or more tracks extending at least between the two channel points, the power conductor and/or signal conductor is/are one or more strips running along the one or more tracks at least between the two channel points.

The one or more strips running along the one or more tracks thereby forms one or more conductor rails or bus rails.

The one or more tracks and thereby the one or more strips are positioned along an inner face of the channel.

Thereby, the linear manipulator can be made more compact (i.e. smaller width) compared to the solution with one or more cable chains as the channel can be made narrower.

The channel may comprise three tracks with three power strips for providing power to the equipment.

The channel may further comprise three tracks with three power strips for providing power to the equipment.

The channel may further comprise three tracks with three signal strips for providing a control signal to the equipment. The three signal strips enable DMX512.

The wagon may be provided with carbon contacts adapted for engaging with the one or more conductor rails or bus rails i.e. strips in the tracks.

In an embodiment, the drag band may extend from outside the body and into the channel, and the motor is connected to a part of the drag band outside the body.

Thereby it becomes easier to service the motor and to install the motor.

The drag band may extend between two wheels, wherein one of the wheels is positioned outside the body. The motor will drive the wheel outside the body.

In an embodiment, the drag band and the motor may be positioned inside the channel.

In an embodiment, the wagon may comprise a conduit through the wagon such that power and/or signal cables can be pulled through the conduit for connecting the equipment to be displaced with the power conductor and/or the signal conductor inside the channel.

In an embodiment, the wagon may comprise a conduit through the bottom of the internal part to the external part, the wagon having through the conduit one or more cables connected to the power conductor and/or the signal conductor and the wagon being adapted at the external part for connecting with the equipment to be moved.

The conduit limits the number of cables external to the linear manipulator further as the cables are inside the wagon.

The conduit may be adapted at the external part for connecting with the equipment to be moved by having a female power plug and/or a female signal plug.

In an embodiment there is a plastic piece positioned between the corresponding rails and the rail grippers.

The plastic piece reduces friction between the rail and the rail grippers, which friction can be too high such that the equipment cannot be moved with a sufficient precession.

This is especially the case if the rails and rail grippers are both made of metal such as aluminium.

In an embodiment the body and/or wagon is substantially made of aluminium.

Aluminium is a light weight metal with sufficient strengths and thus, the linear manipulator is able to be light weight while still having the strength to carry heavy equipment.

An aspect of the invention is provided by a body for a linear manipulator.

The body may comprise
an internal, longitudinal channel, which channel is parallel to an axis between two channel points,
a longitudinal opening extending between the two channel points,
a pair of rails connected to the body and extending parallel to the axis,
a power conductor positioned inside the channel and being capable of extending between the two channel points for providing power,
a drag band extending parallel to the axis, wherein the pair of rails, and the endless band at least extending between the two channel points relative to the axis.

The body is adapted to be connected with a wagon and a motor and thereby becomes a linear manipulator. Thereby, the body becomes a self-contained system which may be connected with any wagon suitable for the channel and any motor.

The body may further comprise one or more cable chains as previously described.

The body may further comprise one or more tracks and one or more strips as previously described.

An aspect of the invention is provided by the use of a linear manipulator for displacing equipment.

### DESCRIPTION OF THE DRAWING

Embodiments of the invention will be described in the figures, whereon:

FIG. 1 illustrates two embodiments of a body for a linear manipulator;

FIG. 2 illustrates a wagon;

FIG. 3 illustrates a body for a linear manipulator and a wagon;

FIG. 4 illustrates a perspective view of a linear manipulator;

FIG. 5 illustrates an end view of a linear manipulator; and

FIG. 6 illustrates an embodiment of a linear manipulator having a cable chain.

### DETAILED DESCRIPTION OF THE INVENTION

| Item | No |
|---|---|
| Linear manipulator | 10 |
| Body | 20 |
| Pair of rails | 22 |
| Plastic piece | 23 |
| Channel | 24 |
| Channel points | 26I, 26II |
| Tracks | 27 |
| Opening | 28 |
| Power conductor | 30 |
| Signal conductor | 32 |
| Strips | 34 |
| Drag band | 40 |
| Wagon | 50 |
| Internal part | 52 |
| External part | 54 |
| Pair of Rail grippers | 56 |
| Band connector | 58 |
| Contacts | 60 |
| Conduit | 62 |
| Cable chain | 70 |
| Motor | 90 |
| Axis | 100 |

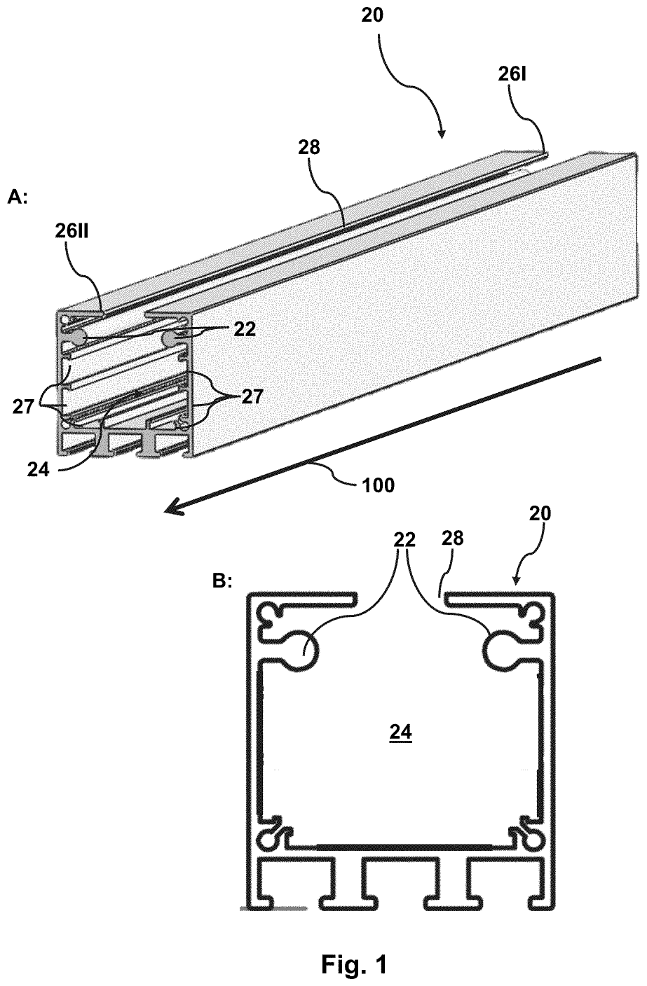

FIG. 1 illustrates two embodiments of a body 20 for a linear manipulator 10 (not shown in FIG. 1).

In FIG. 1A the body 20 comprises an internal, longitudinal channel 24. The channel 24 is parallel to an axis 100 between two channel points 261, 2611.

The two channel points 261, 2611 define a distance over which the linear manipulator 10 will be able to displace equipment.

The channel 24 has a longitudinal opening 28 extending between the two channel points 261, 2611. Thereby, the channel 24 is open along the opening 28.

The body 20 comprises a pair of rails 22 connected to the body 20 and extending parallel to the axis 100. In the present embodiment the pair of rails 22 is positioned inside the channel 24 such that the rails face each other, which will make the displacement of the wagon more stable and enable the entire construct to be made more compact.

The body comprises six tracks 27 inside the channel 24, which tracks 27 extend between the two channel points 261, 2611, the tracks 27 are adapted for receiving and holding one or more strips 34 (not shown). The strips 34 will be able to transfer power and/or signal to the wagon 50.

In this embodiment three of the tracks 27 will be equipped with strips 34 for transferring power, i.e. the strips will function as power conductors 30 positioned inside the channel and they will extend at least between the two channel points 261, 2611 for providing power along this distance. Three of the tracks 27 will be equipped with strips 34 for transferring a DMX512 signal to the wagon, thus the strips 34 will be signal conductors 32.

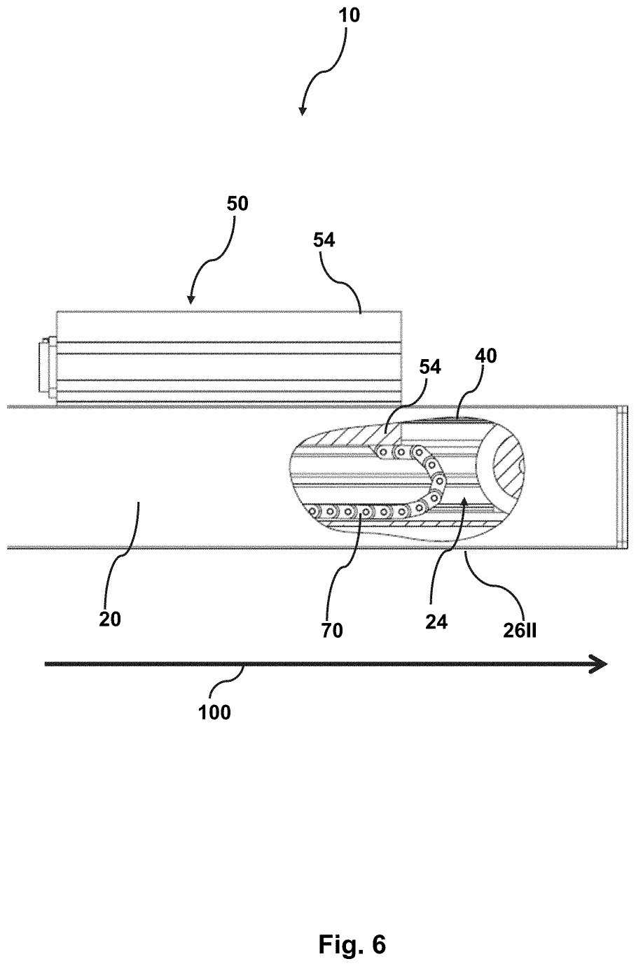

FIG. 1B the body 20 does not comprise tracks 27 as the power and signal is to be provided to the wagon 50 and thus equipment to be moved by one or more cables positioned in a cable chain 70 (not shown, see FIG. 6). The skilled person would know how to correctly install the cable chain 70 into the channel 24. Thereby, it is able to have a signal cable such as a Cat-5 cable or the like.

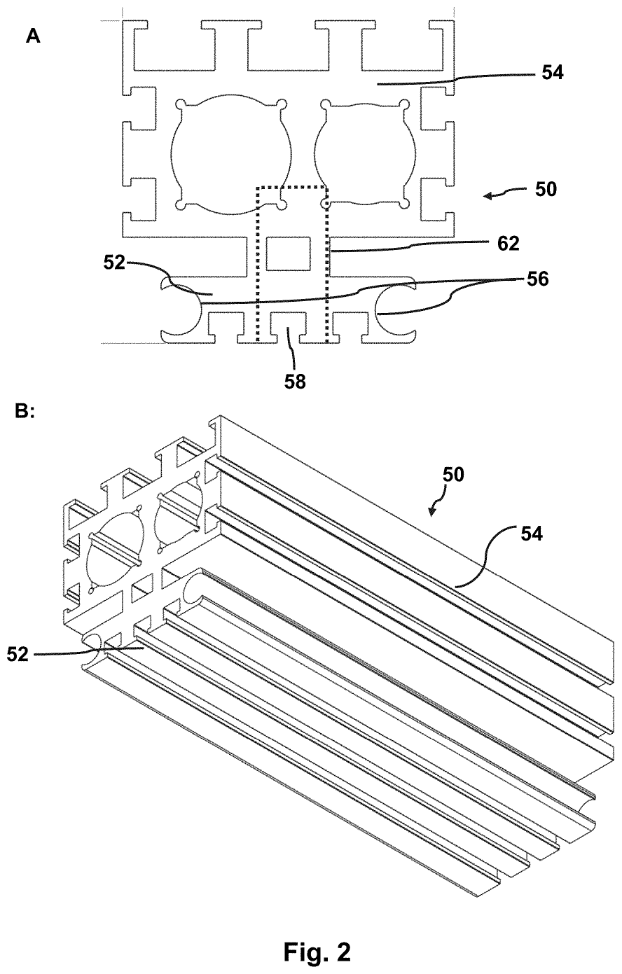

FIG. 2 illustrates a wagon 50 in a side view (A) and in a perspective view (B).

The wagon 50 comprises an internal part 52 to be positioned inside a channel 24 of a body such as the body disclosed in FIG. 1. The internal part 52 is connected to an external part 54 to be positioned outside a channel of a body, such as the body disclosed in FIG. 1.

The wagon 50 further comprises a pair of rail grippers 56 adapted for slidably engaging a pair of rails 22. In this embodiment the pair of rail grippers 56 is placed at the internal part 52 as the wagon 50 is adapted for a body as shown in FIG. 1A-B.

The wagon comprises a band connector 58 adapted for connecting with a drag band 40 (not shown), in this embodiment the band connector 58 is the centre T-track. The skilled person would know how to connect the band connector 58 with a drag band 40.

The external part 50 has two recesses for connection with power and signal. The recesses may be equipped with plugs, such that equipment to be moved easily can be connected to power and signal i.e. control signal.

The external part 54 has several T-tracks for holding equipment in various positions.

The wagon 50 comprises a conduit 62 through the bottom of the internal part 52 to the external part 54. The conduit 62 is represented in FIG. 2A by a dashed line. The conduit 62 is used to pull one or more cables connecting the external part 54 of the wagon 50 to the internal part 52 of the wagon 50 and when in intended use, the conduit 62 is used to connect power conductor(s) 30 and signal conductor(s) 32 with the equipment to be moved, thereby at least limiting or preventing cables external to the linear manipulator 10 with the exception of the cables connecting the wagon and the equipment.

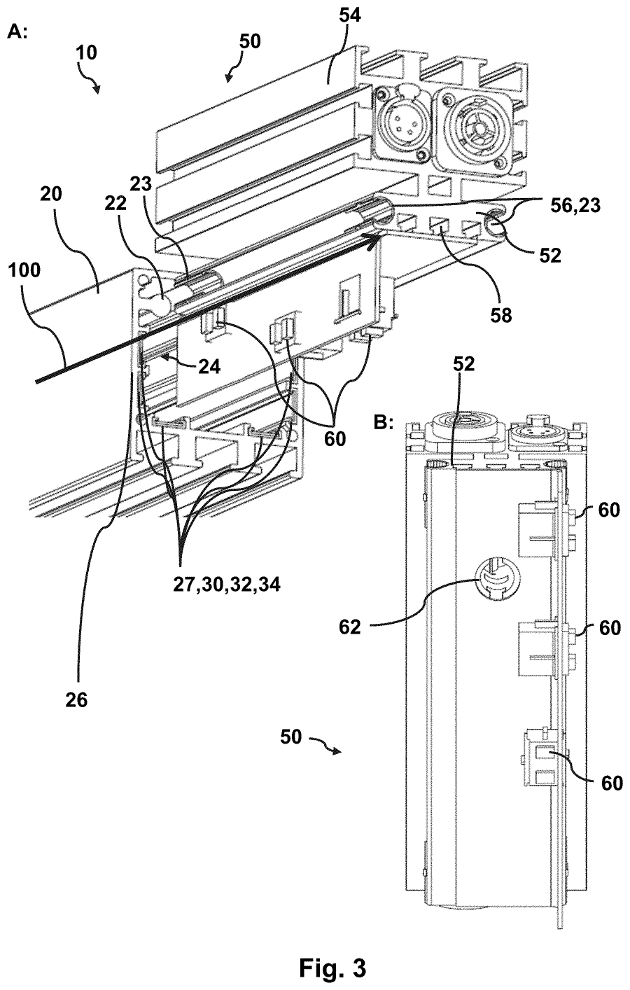

FIG. 3A illustrates a body 20 for a linear manipulator 10 and a wagon 50, and FIG. 3B illustrates a bottom view of the wagon 50.

The disclosed body 20 is identical to the embodiment disclosed in FIG. 1A and the wagon 50 have the same technical features of the embodiment disclosed in FIG. 2.

The wagon 50 is inserted into the channel 24 along the displacement axis 100.

The pair of rail grippers 56 is equipped with four plastic pieces 23 for limiting the frictional force between the pair of rail grippers 56 and the pair of rails 22, thereby making it easier to displace the wagon 50.

The channel 24 is equipped with six tracks 27 each track having a strip 34 which may form part of a power conductor 30 or a signal conductor 32. The strips 34 are isolated from the body 20 and the skilled person would know how to isolate the strips 34 i.e. with the use of plastics or another non-conductive material.

The wagon 50 in this embodiment is holding at the internal part 52 an L-piece with three carbon contacts 60 for connecting with three strips 34 in the channel 24. The skilled person would know how to connect the three carbon contacts 60 with cables and how to pull the cable through the conduit 62 (FIG. 3B). Thereby, the equipment to be moved can be connected to power.

The wagon 50 could at the internal part 52 be holding a U-piece with three carbon contacts 60 for connecting with six strips 34 in the channel 24. The skilled person would know how to connect the three carbon contacts 60 with cables and how to pull the cable through the conduit 62 (FIG. 3B). Thereby, the equipment to be moved can be connected to power and DMX-512 control signal or any other control signal capable of being transferred over three strips.

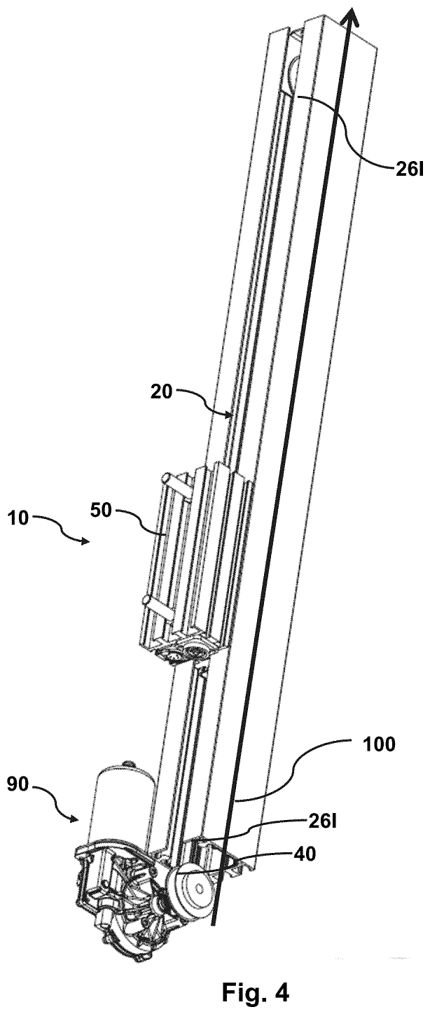

FIG. 4 illustrates a linear manipulator 10 for a programmable stage installation.

The linear manipulator 10 comprises a body 20. The body 20 may be the embodiment disclosed in FIG. 1A or 1B.

The linear manipulator 10 comprises a wagon 50, the wagon may have the features disclosed in FIG. 2.

The linear manipulator 10 further comprises a (not shown) power conductor 30 positioned inside the channel 24 and being capable of extending between the two channel points 261, 2611 for providing power.

The linear manipulator 10 further comprises a drag band 40 extending parallel to the axis 100 between the two rollers at or near the two channel points 261, 2611.

The linear manipulator 10 further comprises a motor (90) adapted for driving the drag band 40 by being connected to one of the rollers.

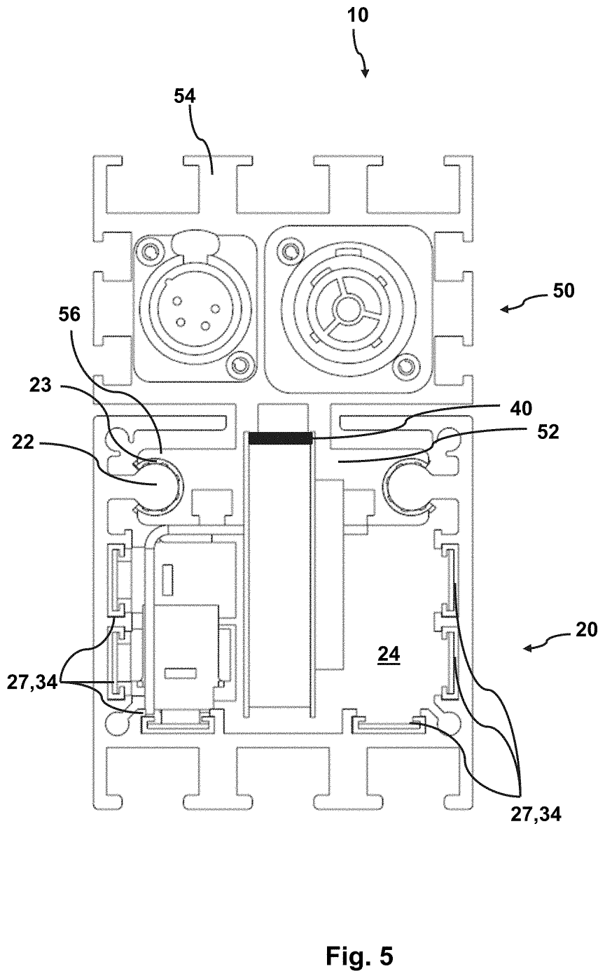

FIG. 5 illustrates a front view of a linear manipulator 10. The linear manipulator 10 is the front view of the embodiment shown in FIG. 3 if the wagon 50 is inserted into the channel 24. However, FIG. 5 also discloses the drag band 40 attached to the roller. The linear manipulator 10 will have a roller in the opposite end, which roller would be connected to a not shown motor 90.

FIG. 6 illustrates an end view of a linear manipulator 10 where the body 20 has at least the same feature as FIG. 1B. The figure also discloses the displacement axis 100.

A drag chain 70 is positioned along the channel and is capable of extending between the two channel points 261, 2611 (Only 2611 is shown). The drag chain 70 is connected to the internal part 52 of the wagon 50.

The wagon 50 may have all the features disclosed in FIG. 2.

The wagon 50 is controllably displaced by the drag band 40 extending between two rollers wherein one roller is shown in the figure.

The drag chain 70 may have a power conductor 30 such as a power cable and/or a signal conductor 32 such as a Cat-5 cable or a DMX cable.

The power conductor 30 and/or signal conductor 32 may extend up through a not shown conduit 62 such that equipment may directly be connected to the power conductor 30 and/or signal conductor 32.

1. A linear manipulator for a programmable stage installation, the linear manipulator comprises:
a body having an internal, longitudinal channel, the channel extending parallel to an axis between two channel points, a longitudinal opening extending between the two channel points, and a pair of rails connected to the body and extending parallel to the axis,
a power conductor positioned inside the channel and configured and arranged to extend between the two channel points for providing power,
a drag band extending parallel to the axis,
a motor configured and arranged to drive the drag band,
a wagon including a pair of rail grippers configured and arranged for slidably engaging the pair of rails, and a band connector connected to the drag band, the wagon configured and arranged for attachment with equipment to be displaced along the linear manipulator, the wagon further including a power connector configured and arranged for connecting the equipment to be moved with the power conductor, wherein the pair of rails and the drag band at least extend between the two channel points relative to the axis.

2. The linear manipulator according to claim 1, wherein the wagon further includes an internal part positioned inside the channel, the internal part being connected to an external part positioned outside the channel, the external part configured and arranged for attachment with the equipment to be displaced along the linear manipulator.

3. The linear manipulator according to claim 1, further including a signal conductor positioned inside the channel and configured and arranged for extending between the two channel points for providing a control signal, and the wagon further includes a signal connector configured and arranged for connecting the equipment to be moved with the signal conductor.

4. The linear manipulator of claim 1, further including one or more cable chains positioned inside the channel and configured and arranged to extend between the two channel points, and the power conductor being positioned inside the one or more cable chains and the one or more cable chains being connected to the wagon.

5. The linear manipulator of claim 1, wherein the channel includes one or more tracks extending at least between the two channel points, and the power conductor being one or more strips running along the one or more tracks at least between the two channel points.

6. The linear manipulator of claim 2, wherein the wagon further includes a conduit through the bottom of the internal part to the external part, the conduit configured and arranged to receive one or more cables connected to the power conductor and/or a signal conductor and the wagon configured and arranged at the external part for connecting with the equipment to be moved.

7. The linear manipulator of claim 1, further including a plastic piece positioned between the corresponding pair of rails and the pair of rail grippers.

8. The linear manipulator of claim 1, wherein the body and/or wagon is substantially made of aluminium.

9. A body for a linear manipulator, the body comprising
an internal, longitudinal channel that extends parallel to an axis between two channel points,
a longitudinal opening extending between the two channel points,
a pair of rails connected to the body and extending parallel to the axis,
a power conductor positioned inside the channel and configured and arranged for extending between the two channel points for providing power,
a drag band extending parallel to the axis,
wherein the pair of rails and the drag band extend between the two channel points relative to the axis.

10. Use of a linear manipulator according to claim 1 for displacing equipment.

11. The linear manipulator of claim 3, further including one or more cable chains positioned inside the channel and configured and arranged to extend between the two channel points and the signal conductor being positioned inside the one or more cable chains and the one or more cable chains being connected to the wagon.

12. The linear manipulator of claim 3, wherein the channel includes one or more tracks extending at least between the two channel points and the signal conductor being one or more strips running along the one or more tracks at least between the two channel points.
